(19) United States
(12) Patent Application Publication
(10) Pub. No.: US 2024/0072964 A1
(43) Pub. Date: Feb. 29, 2024

(54) Transmission of Single-Port Reference Signal Resources

(71) Applicant: Telefonaktiebolaget LM Ericsson (publ), Stockholm (SE)

(72) Inventors: Andreas Nilsson, Göteborg (SE); Pär Ankel, Nödinge (SE); Sven Petersson, Sävedalen (SE); Fredrik Athley, Västra Frölunda (SE)

(21) Appl. No.: 18/280,276

(22) PCT Filed: Mar. 5, 2021
(86) PCT No.: PCT/EP2021/055692

§ 371 Date: Sep. 5, 2023

(51) Int. Cl. H04L 5/00

(52) U.S. Cl. CPC H04L 5/005; H04L 5/0007

(57) ABSTRACT

There is provided mechanisms for transmission of single-port reference signal resources. A method is performed by a network node. The method comprises transmitting, as part of performing a beam selection procedure with a user equipment, two single-port reference signal resources. A first of the two single-port reference signal resources is transmitted over a first polarization. A second of the two single-port reference signal resources is transmitted over a second polarization. The two single-port reference signal resources are time-wise overlapping when transmitted.

### TECHNICAL FIELD

Embodiments presented herein relate to a method, a network node, a computer program, and a computer program product for transmission of single-port reference signal resources.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different carrier frequencies could be needed. For example, low such frequency bands could be needed to achieve sufficient network coverage for wireless devices and higher frequency bands (e.g. at millimetre wavelengths (mmW), i.e. near and above 30 GHz) could be needed to reach required network capacity. In general terms, at high frequencies the propagation properties of the radio channel are more challenging and beamforming both at the network node of the network and at the wireless devices might be required to reach a sufficient link budget.

Narrow beam transmission and reception schemes might be needed at such high frequencies to compensate the expected high propagation loss. For a given communication link, a respective beam can be applied at both the network-end (as represented by a network node or its transmission and reception point, TRP) and at the user-end (as represented by a user equipment), which typically is referred to as a beam pair link (BPL). A BPL (i.e. both the beam used by the network node and the beam used by the user equipment) is expected to be discovered and monitored by the network using measurements on downlink reference signals, such as channel state information reference signals (CSI-RS) or Synchronization Signal Blocks (SSBs), used for beam management.

A beam selection procedure can be used for discovery and maintenance of beam pair links. In some aspects, the beam selection procedure is defined in terms of a P-1 sub-procedure, a P-2 sub-procedure, and a P-3 sub-procedure.

The CSI-RS for beam management can be transmitted periodically, semi-persistently or aperiodically (event triggered) and they can be either shared between multiple user equipment or be device-specific. The SSBs are transmitted periodically and are shared for all user equipment. In order for the user equipment to find a suitable network node beam, the network node, during the P-1 sub-procedure, transmits the reference signal in different transmission (TX) beams on which the user equipment performs measurements, such as reference signal received power (RSRP), and reports back the N best TX beams (where N can be configured by the network). Furthermore, the transmission of the reference signal on a given TX beam can be repeated to allow the user equipment to evaluate a suitable reception (RX) beam.

Reference signals that are shared between all user equipment served by the TRP might be used to determine a first coarse direction for the user equipment. It could be suitable for such a periodic TX beam sweep at the TRP to use SSB as the reference signal. One reason for this is that SSBs are anyway transmitted periodically (for initial access/synchronization purposes) and SSBs are also expected to be beamformed at higher frequencies to overcome the higher propagation losses noted above.

A finer beam sweep in more narrow beams than used during the P-1 sub-procedure might then be performed at the network node during a P-2 sub-procedure to determine a more detailed direction for each user equipment. Here, the CSI-RS might be used as reference signal. As for the P-1 sub-procedure, the user equipment performs measurements, such as reference signal received power (RSRP), and reports back the N best TX beams (where N can be configured by the network).

Furthermore, the CSI-RS transmission in the transmission beam selected during the P-2 sub-procedure can be repeated in a P-3 sub-procedure to allow the user equipment to evaluate suitable RX beams at the user equipment.

However, there is still a risk for polarization mismatching. In turn, this could result in that the optimal TX beam and/or RX beam (i.e., the TX beam and/or RX beam yielding highest throughput, signal to interference plus noise ratio (SINR), etc.) is not selected during the beam selection procedure.

Hence, there is still a need for an improved, in terms of yielding selection of optimal TX beam and/or RX beam, beam selection procedure.

### SUMMARY

An object of embodiments herein is to address the above issues and enable reliable quality measurements to be obtained by the network node for use during a beam selection procedure.

According to a first aspect there is presented a method for transmission of single-port reference signal resources. The method is performed by a network node. The method comprises transmitting, as part of performing a beam selection procedure with a user equipment, two single-port reference signal resources. A first of the two single-port reference signal resources is transmitted over a first polarization. A second of the two single-port reference signal resources is transmitted over a second polarization. The two single-port reference signal resources are time-wise overlapping when transmitted.

According to a second aspect there is presented a network node for transmission of single-port reference signal resources. The network node comprises processing circuitry. The processing circuitry is configured to cause the network node to transmit, as part of performing a beam selection procedure with a user equipment, two single-port reference signal resources. A first of the two single-port reference signal resources is transmitted over a first polarization. A second of the two single-port reference signal resources is transmitted over a second polarization. The two single-port reference signal resources are time-wise overlapping when transmitted.

According to a third aspect there is presented a network node for transmission of single-port reference signal resources. The network node comprises a transmit module configured to transmit, as part of performing a beam selection procedure with a user equipment, two single-port reference signal resources. A first of the two single-port reference signal resources is transmitted over a first polarization. A second of the two single-port reference signal resources is transmitted over a second polarization. The two single-port reference signal resources are time-wise overlapping when transmitted.

According to a fourth aspect there is presented a computer program for transmission of single-port reference signal resources, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, by transmitting single-port reference signal resources as disclosed above, this enables the network node to obtain reliable quality measurements during the beam selection procedure.

Advantageously, these aspects enable the symbol overhead (and thereby also the latency) to be reduced for the beam selection procedure.

Advantageously, these aspects can be used for a beam selection procedure in the form of a P-2 sub-procedure.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 schematically illustrates a beam selection procedure according to an embodiment;

FIG. 3 schematically illustrate transmission of reference signal resources from a network node according to an example;

FIG. 4 is a flowchart of methods according to embodiments;

FIGS. 5, 6, 7, 8, 9, and 10 schematically illustrate transmission of reference signal resources from a network node according to embodiments;

FIG. 11 is a schematic diagram showing functional units of a network node according to an embodiment;

FIG. 12 is a schematic diagram showing functional modules of a network node according to an embodiment;

FIG. 13 shows one example of a computer program product comprising computer readable storage medium according to an embodiment;

FIG. 14 is a schematic diagram illustrating a telecommunication network connected via an intermediate network to a host computer in accordance with some embodiments; and

FIG. 15 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

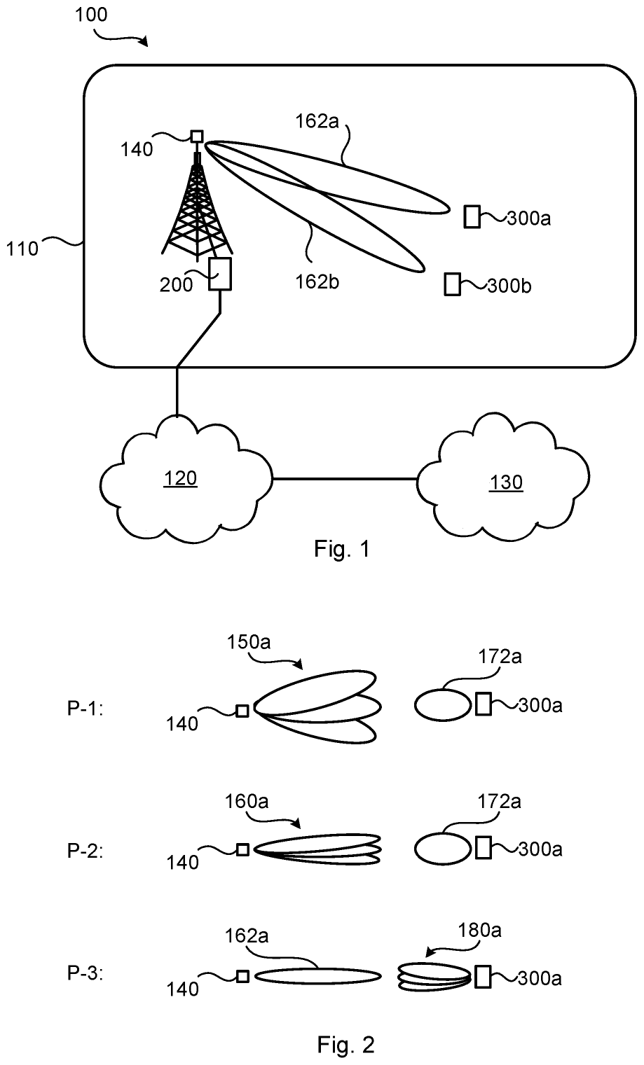

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, or any evolvement thereof, and support any 3GPP telecommunications standard, where applicable.

The communication network 100 comprises a network node 200 configured to provide network access to user equipment, as represented by user equipment 300a and user equipment 300b, in a radio access network 110. The radio access network 110 is operatively connected to a core network 120. The core network 120 is in turn operatively connected to a service network 130, such as the Internet. The user equipment 300a, 300b are thereby enabled to, via the network node 200, access services of, and exchange data with, the service network 130.

The network node 200 comprises, is collocated with, is integrated with, or is in operational communications with, a transmission and reception point (TRP) 140. The network node 200 (via its TRP 140) and the user equipment 300a, 300b are configured to communicate with each other in directional beams, as illustrated at reference numerals 162a, 162. In this respect, directional beams that could be used both as TX beams and RX beams will hereinafter simply be referred to as directional beams.

Examples of network nodes 200 are radio access network nodes, radio base stations, base transceiver stations, Node Bs, evolved Node Bs, gNBs, access points, access nodes, and backhaul nodes. Examples of user equipment 300a, 300b are wireless devices, mobile stations, mobile phones, handsets, wireless local loop phones, smartphones, laptop computers, tablet computers, network equipped sensors, network equipped vehicles, and so-called Internet of Things devices.

FIG. 2 schematically illustrates a beam selection procedure consisting of three sub-procedures, referred to as P-1, P-2, and P-3 sub-procedures. These three sub-procedures will now be disclosed in more detail with reference to one of the user equipment 300a, 300b.

One main purpose of the P-1 sub-procedure is for the network node 200 to find a coarse direction towards the user equipment 300a by transmitting reference signals in wide, but narrower than sector, beams that are swept over the whole angular sector. The TRP 140 is expected to, for the P-1 sub-procedure, utilize beams, according to a spatial beam pattern 150a, with rather large beam widths. During the P-1 sub-procedure, the reference signals are typically transmitted periodically and are shared between all user equipment 300a, 300b served by the network node 200 in the radio access network 110. The user equipment 300a uses a wide, or even omni-directional beam for receiving the reference signals during the P-1 sub-procedure, according to a spatial beam pattern 172a. The reference signals might be periodically transmitted channel state information reference signals (CSI-RS) or synchronization signal blocks (SSB). The user equipment 300a might then to the network node 200 report the N≥1 best beams and their corresponding quality values, such as reference signal received power (RSRP) values. The beam reporting from the user equipment 300a to the network node 200 might be performed rather seldom (in order to save overhead) and can be either periodic, semi-persistent or aperiodic.

One main purpose of the P-2 sub-procedure is to refine the beam selection at the TRP 140 by the network node 200 transmitting reference signals whilst performing a new beam sweep with more narrow directional beams, according to a spatial beam pattern, or set of directional beams, 160a, than those beams used during the P-1 sub-procedure, where the new beam sweep is performed around the coarse direction, or beam, reported during the P-1 sub-procedure. Hence, the beams in the set of directional beams 160a are not omni-directional. During the P-2 sub-procedure, the user equipment 300a typically uses the same beam as during the P-1 sub-procedure, according to a spatial beam pattern 172a. The user equipment 300a might then to the network node 200 report the N≥1 best beams and their corresponding quality values, such as reference signal received power (RSRP) values. One P-2 sub-procedure might be performed per each user equipment 300a or per each group of user equipment 300a, 300b. The reference signals might be periodically, aperiodically or semi-persistently transmitted CSI-RS. The P-2 sub-procedure might be performed more frequently than the P-1 sub-procedure in order to track movements of the user equipment 300a and/or changes in the radio propagation environment.

One main purpose of the P-3 sub-procedure is for user equipment 300a utilizing analog beamforming, or digital wideband (time domain beamformed) beamforming, to find its own best beam. During the P-3 sub-procedure, the reference signals are transmitted, according to a spatial beam pattern, defined by directional beam 162a, in the best reported beam of the P-2 sub-procedure whilst the user equipment 300a performs a beam sweep, according to a spatial beam pattern 180a. Directional beam 162a is thus one of the directional beams 162a:162p in the set of beams 160a. The P-3 sub-procedure might be performed at least as frequently as the P-2 sub-procedure in order to enable the user equipment 300a to compensate for blocking, and/or rotation.

One alternative way for the user equipment 300a to find its own best directional beam, instead of the network node 200 transmitting reference signals during a P-3 sub-procedure, is to let the user equipment 300a evaluate different own direction beams during periodic transmission of reference signals, such as SSBs, for example during the P-1 sub-procedure. Since each SSB consists of four orthogonal frequency-division multiplexing (OFDM) symbols, a maximum of four directional beams at the user equipment 300a can be evaluated during each SSB transmission.

One drawback, however, with the user equipment 300a finding its own best directional beam based on transmission of SSBs is that an SSB only has one port (while CSI-RS can be transmitted with two ports), and hence the SSB is only transmitted over one single polarization (in each unique direction). This implies that the user equipment 300a, 300b most likely only will evaluate suitable directional beams for one polarization. In case of polarization fading there is a risk that a less than optimal directional beam is selected by the user equipment 300a.

As noted above, there is still a need for an improved, in terms of yielding selection of optimal directional beams, beam selection procedure

In this respect, one CSI-RS resource is transmitted per OFDM symbol, where each CSI-RS resource is precoded over two ports, where a first port corresponds to, for example, a vertically polarized beam and a second port corresponds to, for example, a horizontally polarized beam (other polarizations are also possible). In this respect, the CSI-RS resource consist of a single CSI-RS port, but the single CSI-RS port is transmitted over two antenna ports. This implies that the resulting beam will have a +45 degrees linear polarization (assuming that the phase between the radio chains of the respective polarizations is the same, otherwise other polarizations are possible like circular or elliptic)). In turn, this means that if N CSI-RS resources are used in a P2 beam sweep, N OFDM symbols must be allocated for the P2 beam sweep, which results in rather large overhead and latency.

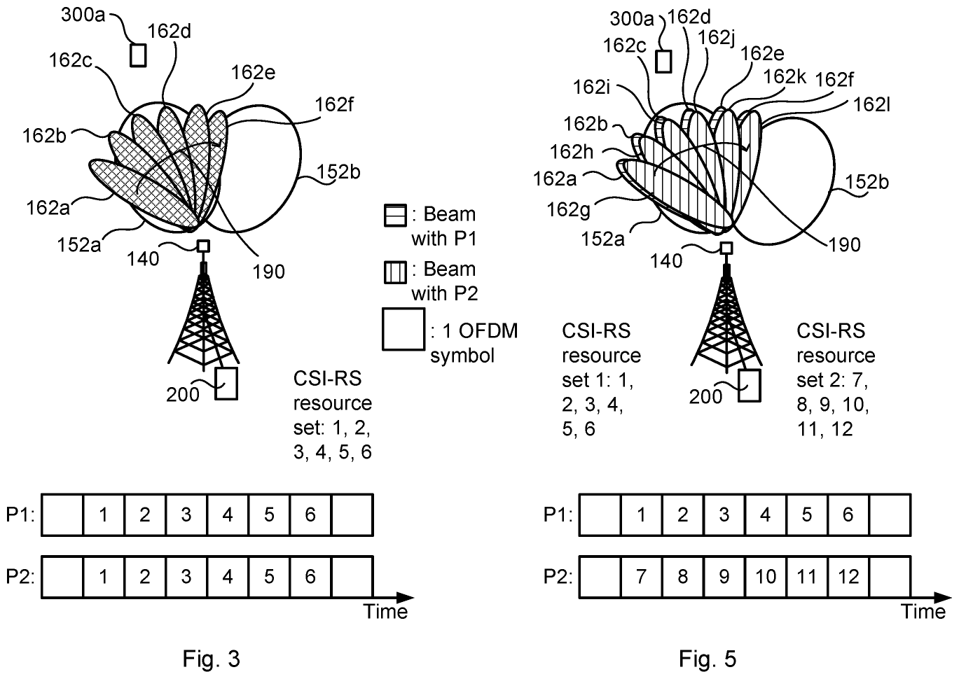

This is illustrated in FIG. 3, which illustrates transmission of reference signal resources, in terms of CSI-RS resources, in directional beams 162a:162f from TRP 140 of network node 200 towards user equipment 300a. Directional beams 162a:162f are confined within the angular interval of directional beam 152a. The transmission of reference signal resources in directional beams 162a:162d can thus represent a P-2 sub-procedure where reference signal resources during a preceding P-1 sub-procedure first having been transmitted in directional beams 152a and 152b. In FIG. 3 six CSI-RS resources 1, 2, 3, 4, 5, and 6 are transmitted from a first port using polarization P1 and a second port using polarization P2. As above, the CSI-RS resource consist of a single CSI-RS port that is transmitted over two antenna ports. Performing a beam sweep, as illustrated by arrow 190, between the beams 162a:162f thus enables the user equipment 300a to evaluate the six beams 162a:162f for a single polarization. Here the single port CSI-RS resources are precoded over both the vertically and horizontally polarized antenna elements, which thus means that only one polarization can be evaluated per OFDM symbol. Hence, in case all six beams need to be evaluated per polarization, six additional OFDM symbols would be required. This issue becomes extra severe if all beams, or a subset of all beams, in a P2 beam sweep should be evaluated for two orthogonal polarizations, since two single port CSI-RS resources are need for every narrow beam that is evaluated for two polarizations.

The embodiments disclosed herein therefore relate to mechanisms for transmission of single-port reference signal resources. In order to obtain such mechanisms there is provided a network node 200, a method performed by the network node 200, a computer program product comprising code, for example in the form of a computer program, that when run on a network node 200, causes the network node 200 to perform the method.

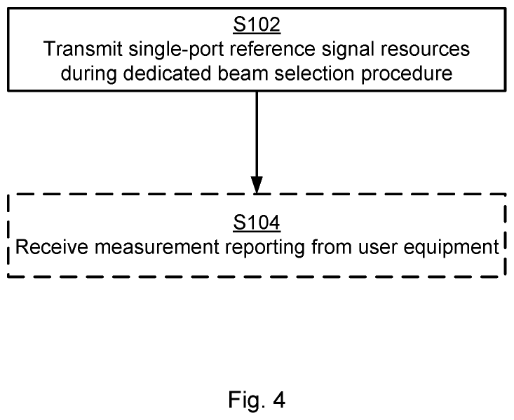

FIG. 4 is a flowchart illustrating embodiments of methods for transmission of single-port reference signal resources. The methods are performed by the network node 200. The methods are advantageously provided as computer programs 1320.

S102: The network node 200 transmits, as part of performing a beam selection procedure with a user equipment 300a, two single-port reference signal resources. A first of the two single-port reference signal resources is transmitted over a first polarization P1. A second of the two single-port reference signal resources is transmitted over a second polarization P2. The two single-port reference signal resources are time-wise overlapping when transmitted.

In this way, since the user equipment 300a reports the best N beam(s) per CSI-RS resource set, it can be ensured that the user equipment 300a reports the best beam per polarization. This could, for example, be beneficial in case for example multi-user multiple-input multiple-output (MU-MIMO) communication is required and the network node 200 needs to know the performance for the user equipment 300a per polarization.

By transmitting single-port reference signal resources as disclosed above, this enables the network node to obtain reliable quality measurements during the beam selection procedure.

This method enables the symbol overhead (and thereby also the latency) to be reduced for the beam selection procedure.

This method can be used for a beam selection procedure in the form of a P-2 sub-procedure.

Embodiments relating to further details of transmission of single-port reference signal resources as performed by the network node 200 will now be disclosed.

In some aspects it is assumed that the user equipment 300a receives at least one of the two single-port reference signal resources and provides measurement reporting thereof to the network node 200. Hence, in some embodiments, the network node 200 is configured to perform (optional) step S104:

S104: The network node 200 receives measurement reporting of the two single-port reference signal resources from the user equipment 300a.

The network node 200 might then, based on the measurement reporting, determine a preferred beam and preferred polarization for coming data or control transmission and/or reception for the user equipment 300a.

In some aspects, the beam selection procedure is a dedicated beam selection procedure, i.e., a procedure dedicated only to beam selection. One examples of such a dedicated beam selection procedure is the above-mentioned P-2 sub-procedure. That is, in some embodiments, the beam selection procedure is a P-2 sub-procedure.

There could be different examples of reference signal resources, and hence different examples of single-port reference signal resources. In some embodiments, each of the two single-port reference signal resources is a CSI-RS.

There could be different relations between the first polarization P1 and the second polarization P2. In some embodiments, the second polarization P2 is orthogonal to the first polarization P1.

There could be different ways to transmit the single-port reference signal resources. In some aspects, the single-port reference signal resources are transmitted in OFDM symbols. Then, since the two single-port reference signal resources are time-wise overlapping when transmitted, this implies that, the two single-port reference signal resources are transmitted in one and the same OFDM symbol.

There may be different ways to organize the single-port reference signal resources. Different aspects relating thereto will now be disclosed in turn.

In some aspects, the single-port reference signal resources belong to one common CSI-RS resource set. That is, in some embodiments, the first single-port reference signal resource and the second single-port reference signal resource are part of a common reference signal resource set.

In some aspects, there are two CSI-RS resource sets. That is, in some embodiments, the first single-port reference signal resource is part of a first reference signal resource set, and the second single-port reference signal resource is part of a second reference signal resource set. A respective single-port reference signal resource from the first reference signal resource set is then at least sometimes transmitted together with a respective single-port reference signal resource from the second reference signal resource set. This applies to the examples illustrated in FIGS. 5, 6, 7, 8, 9, and 10.

In some aspects, there is one separate CSI-RS resource set per polarization. That is, in some embodiments, single-port reference signal resources from the first reference signal resource set are only transmitted over the first polarization P1, and single-port reference signal resources from the second reference signal resource set are only transmitted over the second polarization P2. This applies to the examples illustrated in FIG. 5. In some examples of such embodiments, a respective single-port reference signal resource from the first reference signal resource set is always transmitted together with a respective single-port reference signal resource from the second reference signal resource set. With regards to the above described P-2 sub-procedure, this enables the network node 200 to, as part of performing the beam selection procedure with the user equipment 300a, the network node 200 to attain the N best beams per polarization.

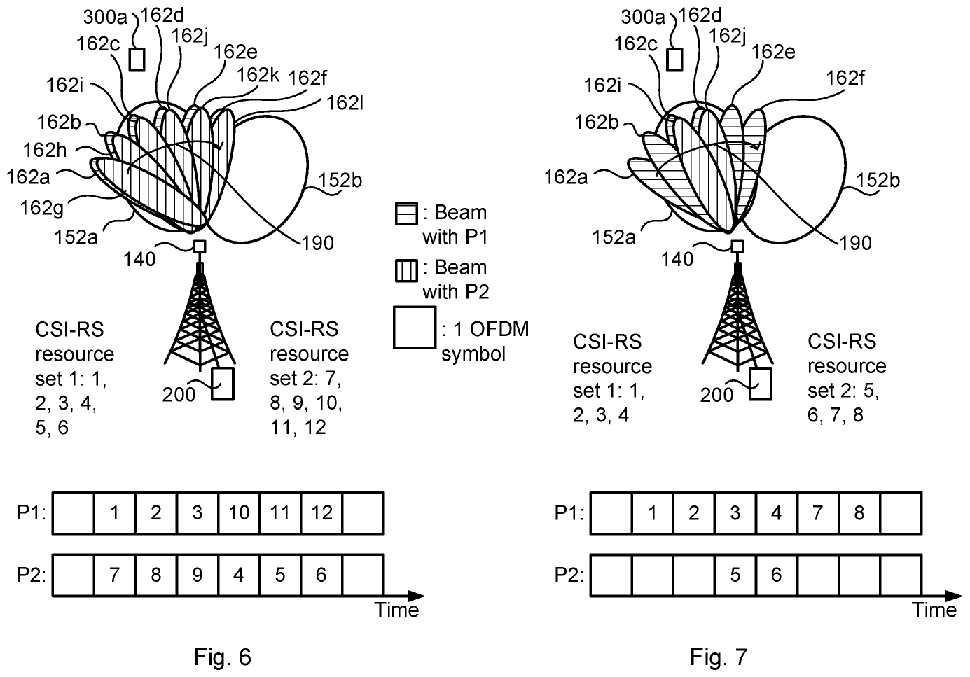

In some aspects, at least one of the CSI-RS resource sets is divided over polarization. That is, in some embodiments, some single-port reference signal resources from the first reference signal resource set are transmitted over the first polarization P1 and other single-port reference signal resources from the first reference signal resource set are transmitted over the second polarization P2. Some single-port reference signal resources from the second reference signal resource set are transmitted over the second polarization P2 and other single-port reference signal resources from the second reference signal resource set are transmitted over the first polarization P1. This applies to the examples illustrated in FIG. 6. In some examples of such embodiments, a respective single-port reference signal resource from the first reference signal resource set is always transmitted together with a respective single-port reference signal resource from the second reference signal resource set.

In some aspects, at each time instant, one CSI-RS resource from each CSI-RS resource set is transmitted. That is, in some embodiments, when one single-port reference signal resource from one of the first and second reference signal resource sets is transmitted over one of the two polarizations P1, P2, another single-port reference signal resource from another of the first and second reference signal resource sets is transmitted over another of the two polarizations P1, P2. This applies to the examples illustrated in FIGS. 5 and 6.

In some aspects, different number of CSI-RS resources are transmitted in each polarization. That is, in some embodiments, the single-port reference signal resources of the first reference signal resource set are transmitted partly over the first polarization P1 and partly over the second polarization P2, and the single-port reference signal resources of the second reference signal resource set are transmitted only over the second polarization P2. This applies to the examples illustrated in FIG. 7. In some examples of such embodiments, a respective single-port reference signal resource from the second reference signal resource set is always transmitted together with a respective single-port reference signal resource from the first reference signal resource set.

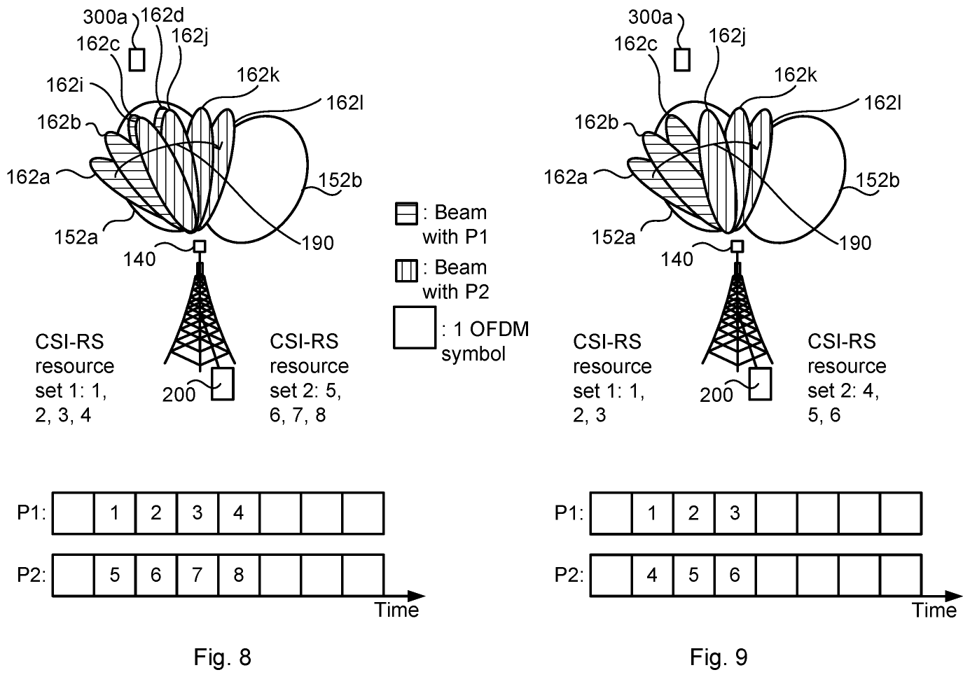

In general terms, the two single-port reference signal resources are transmitted in directional beams, or beams for short. This is illustrated in FIGS. 5 to 10. Further aspects of how the two single-port reference signal resources might be transmitted in beams will now be disclosed. In some embodiments, for each of the polarizations P1, P2, each of the two single-port reference signal resources is transmitted in its own beam 162a:162l. This applies to the examples illustrated in FIGS. 8, 9, 10 (and also FIGS. 5, 6, 7). In some embodiments, single-port reference signal resources of the first reference signal resource set are transmitted in beams of a first beam set 162a:162f. One single-port reference signal resource of the first reference signal resource set is transmitted per beam. Further, single-port reference signal resources of the second reference signal resource set are transmitted in beams of a second beam set 162g:162l. One single-port reference signal resource of the second reference signal resource set is transmitted per beam. This applies to the examples illustrated in FIGS. 8, 9, 10 (and also FIGS. 5, 6, 7).

There might be different relations between the first beam set and the second beam set. In some embodiments, the first beam set and the second beam set are spatially fully overlapping. This applies to the examples illustrated in FIGS. 5 and 6. In some embodiments, the first beam set and the second beam set are partly, but not fully, overlapping. This applies to the examples illustrated in FIGS. 7 and 8. In some embodiments, the first beam set and the second beam set are non-overlapping. This applies to the examples illustrated in FIG. 9.

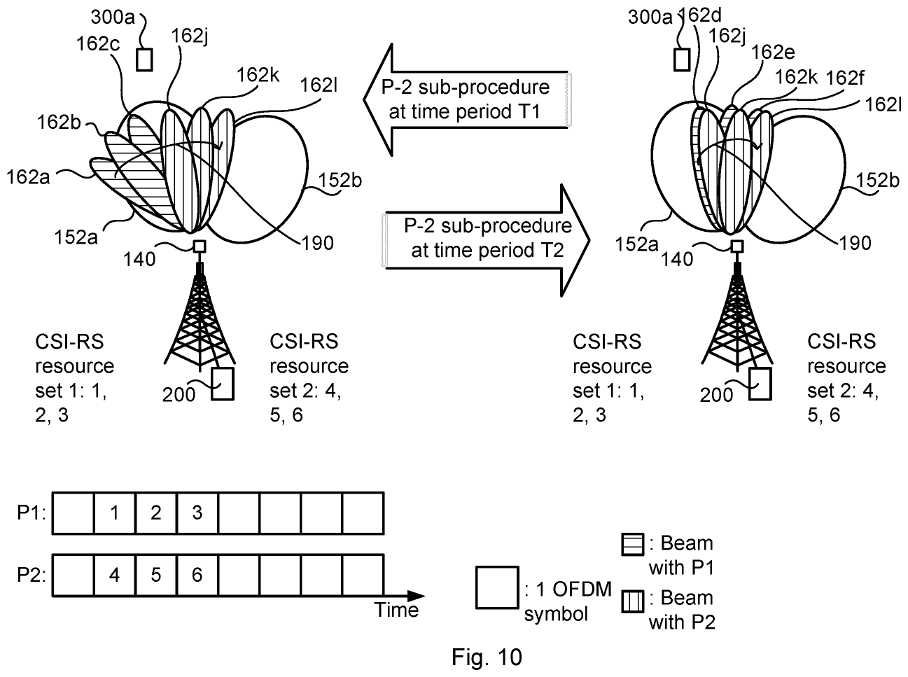

In some aspects, the single-port reference signal resources are transmitted in beams that are alternated over time. This allows one and the same single-port reference signal resource at two different points in time to be transmitted in two different beams. Thus, in some embodiments, the pointing directions of the beams in at least one of the first beam set and the second beam set are time-wise alternated. At a first time instance the first beam set and the second beam set are non-overlapping, and at a second time instance the first beam set and the second beam set at least partly overlapping. This applies to the examples illustrated in FIG. 10.

Reference will now in turn be made to FIGS. 5, 6, 7, 8, 9, and 10. Each of these figures illustrates transmission of single-port reference signal resources, in terms of CSI-RS resources, in directional beams 162a:162l (in some examples less than all these beams) from TRP 140 of network node 200 towards user equipment 300a. Each directional beam is either polarized in the first polarization P1 or the second polarization P2, as specified in each of FIGS. 5, 6, 7, 8, 9, and 10. The directional beams are confined within the angular interval of directional beam 152a. Without loss of generality, the beam selection procedure involves the directional beams to be swept in the direction indicated by arrow 190. The transmission of single-port reference signal resources in the directional beams can thus represent a P-2 sub-procedure where single-port reference signal resources during a preceding P-1 sub-procedure first having been transmitted in directional beams 152a and 152b. The single-port reference signal resources are divided in two CSI-RS resource sets; CSI-RS resource set 1 and CSI-RS resource set 2 with members in each CSI-RS resource sets, as specified in each of FIGS. 5, 6, 7, 8, 9, and 10. In the illustrated examples, the single-port reference signal resources are transmitted in OFDM symbols, one single-port reference signal resource per OFDM symbol, in either the first polarization P1 or the second polarization P2, as specified in each of FIGS. 5, 6, 7, 8, 9, and 10. However, two single-port CSI-RS resources might generally be transmitted in some or all OFDM symbols.

It is here noted that there could be different orders with regards to how the CSI-RS resources are transmitted and how they are mapped to the two polarizations of the antennas at the TRP 140, see for example FIG. 5 and FIG. 6.

It is here also noted that there could be different ways how the CSI-RS resources are mapped to the different beams 162a:162l. For example, in a variation of FIG. 6, it is possible that all six CSI-RS resources in CSI-RS resource set 1 are mapped to beams 162a, 162b, 162c, 162g, 162h, 162i, and that the six CSI-RS resources in CSI-RS resource set 2 are mapped to beams 162d, 162e, 162f, 162j, 162k, 162l.

In the example of FIG. 5, six OFDM symbols are used to evaluate six beams for two orthogonal polarization P1 and P2, i.e., six beams per polarization. This is enabled by configuring a P-2 sub-procedure with two CSI-RS resource sets, where the CSI-RS resources are transmitted such that the respective CSI-RS resource sets fully overlap in the time domain. For each OFDM symbol, one CSI-RS resource is transmitted using polarization P1, and one CSI-RS resource is transmitted using polarization P2. For example, CSI-RS resource 1 from CSI-RS resource set 1 is transmitted in one OFDM symbol simultaneously as CSI-RS resource 7 from CSI-RS resource set 2 is transmitted in another OFDM symbol, and so on. Without loss of generality, CSI-RS resource 1 is transmitted in directional beam 162a of polarization P1 and CSI-RS resource 7 is transmitted in directional beam 162g of polarization P2.

In the example of FIG. 6, six OFDM symbols are used to evaluate six beams for two orthogonal polarization P1 and P2, i.e., six beams per polarization. This is enabled by configuring a P-2 sub-procedure with two CSI-RS resource sets, where the CSI-RS resources are transmitted such that the respective CSI-RS resource sets fully overlap in the time domain. For each OFDM symbol, one CSI-RS resource is transmitted using polarization P1, and one CSI-RS resource is transmitted using polarization P2. In contrast to the example of FIG. 5, some of the CSI-RS resources of CSI-RS resource set 1 are transmitted using polarization P1, whilst others of the CSI-RS resources of CSI-RS resource set 1 are transmitted using polarization P2, and likewise for the CSI-RS resources of CSI-RS resource set 2. For example, CSI-RS resource 10 from CSI-RS resource set 2 is transmitted in one OFDM symbol simultaneously as CSI-RS resource 4 from CSI-RS resource set 1 is transmitted in another OFDM symbol, and so on. Without loss of generality, CSI-RS resource 4 is transmitted in directional beam 162j of polarization P2 and CSI-RS resource 10 is transmitted in directional beam 162d of polarization P1.

In the example of FIG. 7, six OFDM symbols are used to evaluate six beams 162a:162f for polarization P1 but only two beams 162i:162j are evaluated for polarization P2. In this example, there are more CSI-RS resources in CSI-RS resource set 1 than in CSI-RS resource set 2. For example, CSI-RS resource 3 from CSI-RS resource set 1 is transmitted in one OFDM symbol simultaneously as CSI-RS resource 5 from CSI-RS resource set 2 is transmitted in another OFDM symbol, and so on. Without loss of generality, CSI-RS resource 3 is transmitted in directional beam 162c of polarization P1 and CSI-RS resource 5 is transmitted in directional beam 162i of polarization P2.

In the example of FIG. 8, four OFDM symbols are used to evaluate six beams; two beams 162a, 162b are evaluated only for polarization P1, two beams 162c, 162i, 162d, 162j (in this respect, beams 162c and 162i may be regarded as being one and the same beam, but using two different polarizations, and also beams 162d and 162j may be regarded as being one and the same beam, but using two different polarizations) are evaluated for both polarization P1 and polarization P2, and two beams 162k, 162l are evaluated only for polarization P2. In this case all four CSI-RS resources of the two CSI-RS resource sets can have overlapping time slot, since they are single-port resources. For example, CSI-RS resource 1 from CSI-RS resource set 1 is transmitted in one OFDM symbol simultaneously as CSI-RS resource 5 from CSI-RS resource set 2 is transmitted in another OFDM symbol, and so on. Without loss of generality, CSI-RS resource 1 is transmitted in directional beam 162a of polarization P1 and CSI-RS resource 5 is transmitted in directional beam 162i of polarization P2.

In the example of FIG. 9, three OFDM symbols are used to evaluate six beams; three beams 162a, 162b, 162c are evaluated for a first polarization, and three beams 162j 162k, 162l are evaluated for a second polarization. In this case all three CSI-RS resources of the two CSI-RS resource sets can have overlapping time slot, since they will be transmitted with different antennas of the TRP 140. For example, CSI-RS resource 1 from CSI-RS resource set 1 is transmitted in one OFDM symbol simultaneously as CSI-RS resource 4 from CSI-RS resource set 2 is transmitted in another OFDM symbol, and so on. Without loss of generality, CSI-RS resource 1 is transmitted in directional beam 162a of polarization P1 and CSI-RS resource 4 is transmitted in directional beam 162i of polarization P2.

In the example of FIG. 10, three OFDM symbols are used to alternatingly evaluate six beams and three beams by means of the CSI-RS resources being transmitted in beams that are alternated over time. At a first time period T1, six CSI-RS resources are transmitted in three OFDM symbols to evaluate six beams. This is useful in case the network node 200 does not know which is the currently best beam for the user equipment 300a and therefore the network node 200 needs to evaluate all different beams confined within the angular interval of directional beam 152a. At a second time period T2, six CSI-RS resources are transmitted in three OFDM symbols to evaluate three beams. This is useful if the network node 200 knows the currently best beam for the user equipment 300a, and therefore wants to make a more reliable beam sweep only around the currently best beam, such as only in the beams directly neighboring the currently best beam.

Since two single-port reference signal resources can be simultaneously transmitted, this implies that only half the of the total output power of the TRP 140 is available per each CSI-RS resource compared to if one and the same single-port reference signal resource would have been transmitted on both ports (i.e. using both the first polarization P1 and the second polarization P2). This since only half of all the antennas belonging to the TRP 140 are used for transmitting each CSI-RS resource (since only antenna elements of one polarization is used per CSI-RS resource instead of antenna elements of both polarizations). However since CSI-RS resources transmitted as part of a beam sweep of a P-2 sub-procedure are far from being the coverage limited factor, using only antennas of one polarization per CSI-RS resource will not impact the reliability of the P-2 sub-procedure.

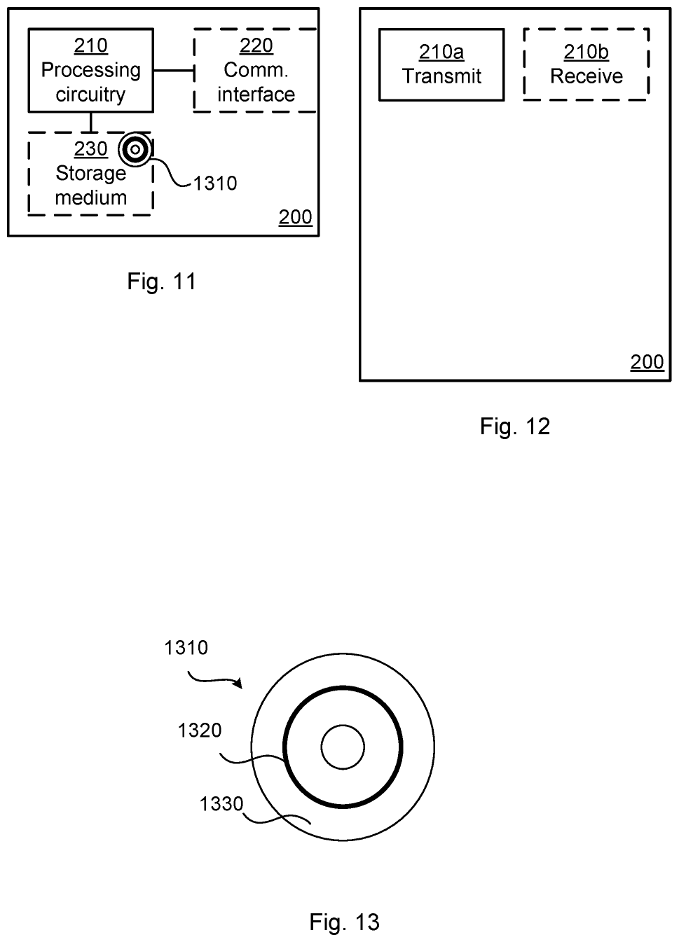

FIG. 11 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310 (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 12 schematically illustrates, in terms of a number of functional modules, the components of a network node 200 according to an embodiment. The network node 200 of FIG. 12 comprises a transmit module 210a configured to perform step S102. The network node 200 of FIG. 12 may further comprise a number of optional functional modules, such as a receive module 210b configured to perform step S104. In general terms, each functional module 210a:210b may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 13. It should also be mentioned that even though the modules correspond to parts of a computer program, they do not need to be separate modules therein, but the way in which they are implemented in software is dependent on the programming language used. Preferably, one or more or all functional modules 210a:210b may be implemented by the processing circuitry 210, possibly in cooperation with the communications interface 220 and/or the storage medium 230. The processing circuitry 210 may thus be configured to from the storage medium 230 fetch instructions as provided by a functional module 210a:210b and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 11 the processing circuitry 210 may be distributed among a plurality of devices, or nodes. The same applies to the functional modules 210a:210b of FIG. 12 and the computer program 1320 of FIG. 13.

FIG. 13 shows one example of a computer program product 1310 comprising computer readable storage medium 1330. On this computer readable storage medium 1330, a computer program 1320 can be stored, which computer program 1320 can cause the processing circuitry 210 and thereto operatively coupled entities and devices, such as the communications interface 220 and the storage medium 230, to execute methods according to embodiments described herein. The computer program 1320 and/or computer program product 1310 may thus provide means for performing any steps as herein disclosed.

In the example of FIG. 13, the computer program product 1310 is illustrated as an optical disc, such as a CD (compact disc) or a DVD (digital versatile disc) or a Blu-Ray disc. The computer program product 1310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320 is here schematically shown as a track on the depicted optical disk, the computer program 1320 can be stored in any way which is suitable for the computer program product 1310.

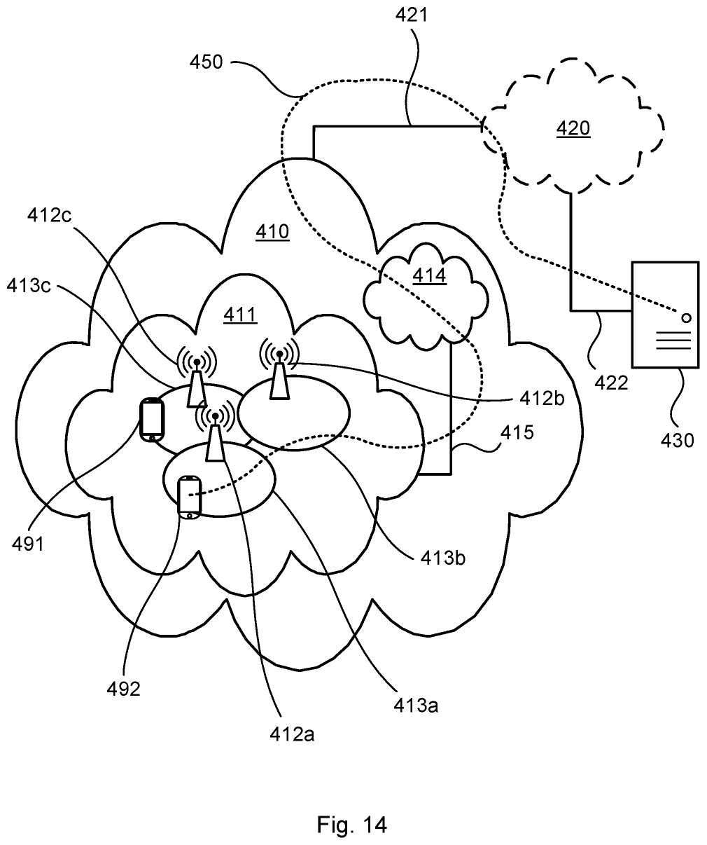

FIG. 14 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 300a, 300b of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

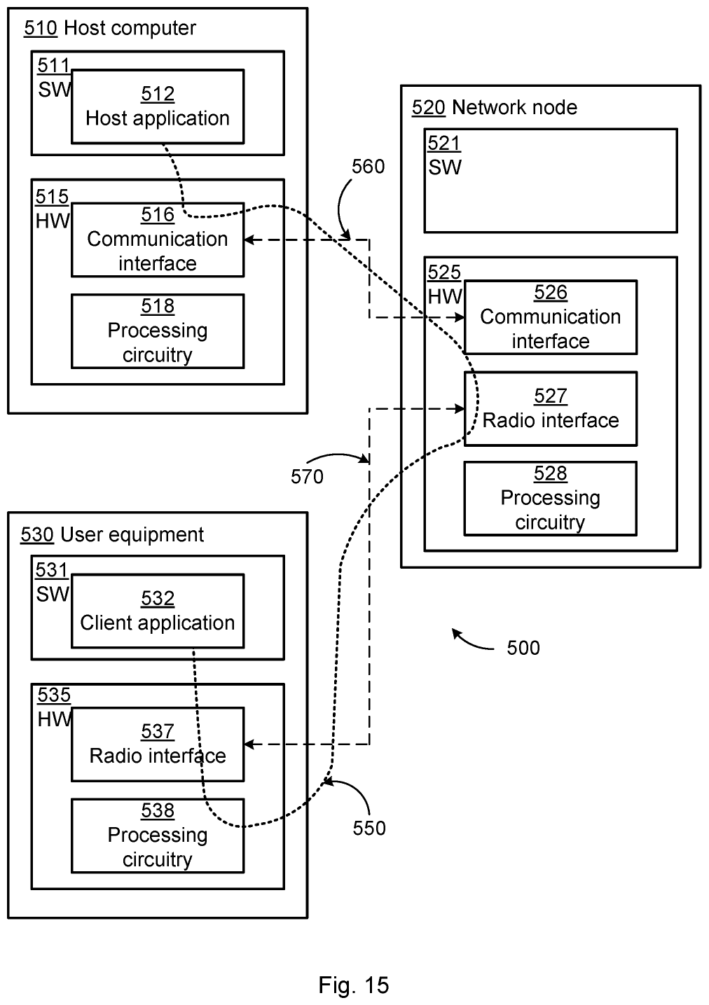

FIG. 15 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 300a, 300b of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1.

Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by radio access network node 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 15 may be similar or identical to host computer 430, one of network nodes 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-26. (canceled)

27. A method for transmission of single-port reference signal resources, the method being performed by a network node, the method comprising:
transmitting, as part of performing a beam selection procedure with a user equipment, two single-port reference signal resources, wherein:
a first of the two single-port reference signal resources is transmitted over a first polarization,
a second of the two single-port reference signal resources is transmitted over a second polarization, and
the two single-port reference signal resources are time-wise overlapping when transmitted.

28. The method of claim 27, wherein the first single-port reference signal resource and the second single-port reference signal resource are part of a common reference signal resource set.

29. The method of claim 27, wherein the first single-port reference signal resource is part of a first reference signal resource set, wherein the second single-port reference signal resource is part of a second reference signal resource set, and when a respective single-port reference signal resource from the first reference signal resource set is at least sometimes transmitted together with a respective single-port reference signal resource from the second reference signal resource set.

30. The method of claim 29, wherein single-port reference signal resources from the first reference signal resource set are only transmitted over the first polarization, and wherein single-port reference signal resources from the second reference signal resource set are only transmitted over the second polarization.

31. The method of claim 30, wherein a respective single-port reference signal resource from the first reference signal resource set is always transmitted together with a respective single-port reference signal resource from the second reference signal resource set.

32. The method of claim 29, wherein some single-port reference signal resources from the first reference signal resource set are transmitted over the first polarization and other single-port reference signal resources from the first reference signal resource set are transmitted over the second polarization, and wherein some single-port reference signal resources from the second reference signal resource set are transmitted over the second polarization and other single-port reference signal resources from the second reference signal resource set are transmitted over the first polarization.

33. The method of claim 32, wherein a respective single-port reference signal resource from the first reference signal resource set is always transmitted together with a respective single-port reference signal resource from the second reference signal resource set.

34. The method of claim 29, wherein, when one single-port reference signal resource from one of the first and second reference signal resource sets is transmitted over one of the two polarizations, another single-port reference signal resource from another of the first and second reference signal resource sets is transmitted over another of the two polarizations.

35. The method of claim 29, wherein the single-port reference signal resources of the first reference signal resource set are transmitted partly over the first polarization and partly over the second polarization, and wherein the single-port reference signal resources of the second reference signal resource set are transmitted only over the second polarization.

36. The method of claim 35, wherein a respective single-port reference signal resource from the second reference signal resource set is always transmitted together with a respective single-port reference signal resource from the first reference signal resource set.

37. The method of claim 29, wherein single-port reference signal resources of the first reference signal resource set are transmitted in beams of a first beam set, one single-port reference signal resource per beam, and wherein single-port reference signal resources of the second reference signal resource set are transmitted in beams of a second beam set, one single-port reference signal resource per beam.

38. The method of claim 37, wherein the first beam set and the second beam set are at least partly overlapping.

39. The method of claim 37, wherein pointing directions of the beams in at least one of the first beam set and the second beam set are time-wise alternated, wherein at a first time instance the first beam set and the second beam set are non-overlapping, and wherein at a second time instance the first beam set and the second beam set at least partly overlapping.

40. The method of claim 27, wherein, for each of the polarizations, each of the two single-port reference signal resources is transmitted in its own beam.

41. The method of claim 27, wherein the two single-port reference signal resources are transmitted in one and the same OFDM symbol.

42. The method of claim 27, wherein the second polarization is orthogonal to the first polarization.

43. The method of claim 27, wherein each of the two single-port reference signal resources is a CSI-RS.

44. The method of claim 27, further comprising:
receiving measurement reporting of the two single-port reference signal resources from the user equipment.

45. A network node for transmission of single-port reference signal resources, the network node comprising processing circuitry, the processing circuitry being configured to cause the network node to:
transmit, as part of performing a beam selection procedure with a user equipment, two single-port reference signal resources, wherein:
a first of the two single-port reference signal resources is transmitted over a first polarization,
a second of the two single-port reference signal resources is transmitted over a second polarization, and
the two single-port reference signal resources are time-wise overlapping when transmitted.

46. A non-transitory computer-readable comprising, stored thereupon, a computer program for transmission of single-port reference signal resources, the computer program comprising computer code configured so that, when run on processing circuitry of a network node, the computer code causes the network node to:
transmit, as part of performing a beam selection procedure with a user equipment, two single-port reference signal resources, wherein:
a first of the two single-port reference signal resources is transmitted over a first polarization,
a second of the two single-port reference signal resources is transmitted over a second polarization, and
the two single-port reference signal resources are time-wise overlapping when transmitted.
